(19) United States
(12) Patent Application Publication
(10) Pub. No.: US 2026/0296496 A1
(43) Pub. Date: Oct. 1, 2026

(54) STEERING LIMITATION DEVICE AND STEERING LIMITATION METHOD

(71) Applicant: TOYOTA JIDOSHA KABUSHIKI KAISHA, Toyota-shi (JP)

(72) Inventor: Yoichiro KATSURA, Mishima-shi (JP)

(73) Assignee: TOYOTA JIDOSHA KABUSHIKI KAISHA, Toyota-shi (JP)

(21) Appl. No.: 19/545,424

(22) Filed: Feb. 20, 2026

(30) Foreign Application Priority Data
Mar. 28, 2025 (JP) 2025-056617

(51) Int. Cl. B60W 60/00; B60W 50/00; B60W 50/14

(52) U.S. Cl. CPC B60W 60/0016; B60W 50/0097; B60W 50/14; B60W 2520/06; B60W 2552/00; B60W 2710/207

(57) ABSTRACT

A steering limitation device includes: a distance calculation unit configured to calculate a lateral distance between a vehicle and a cliff when a road on which the vehicle travels faces the cliff; a displacement amount calculation unit configured to estimate a trajectory of the vehicle when a steering angle change rate of the vehicle in a direction in which the vehicle approaches the cliff is a predetermined value, and calculate a lateral displacement amount of the vehicle corresponding to the trajectory; a guard value setting unit configured to set a guard value for limiting the steering angle change rate by comparing the lateral distance with the lateral displacement amount; and a vehicle controller configured to control the vehicle based on the guard value.

### CROSS-REFERENCE TO RELATED APPLICATION

This application claims priority to Japanese Patent Application No. 2025-056617 filed on Mar. 28, 2025. The disclosure of the above-identified application, including the specification, drawings, and claims, is incorporated by reference herein in its entirety.

### BACKGROUND

### 1. Technical Field

The present disclosure relates to a steering limitation device and a steering limitation method.

### 2. Description of Related Art

Japanese Unexamined Patent Application Publication No. 2024-001501 (JP 2024-001501 A) discloses control when a terrain on a turn outer side with respect to a road is a dangerous terrain, such as a cliff. Specifically, it is disclosed that a target traveling route is set such that the vehicle travels on a path on a turn inner side, and a traveling speed is set such that the vehicle can stop without entering the dangerous terrain.

### SUMMARY

However, in the technology, when a vehicle travels on a road facing a cliff, an unnatural traveling path may be selected or unnecessary deceleration may be performed.

Therefore, in view of the problem, an object of the present disclosure is to appropriately support traveling of a vehicle when the vehicle travels on a road facing a cliff.

The gist of the present disclosure is as follows.
(1) A steering limitation device including: a distance calculation unit configured to calculate a lateral distance between a vehicle and a cliff when a road on which the vehicle travels faces the cliff; a displacement amount calculation unit configured to estimate a trajectory of the vehicle when a steering angle change rate of the vehicle in a direction in which the vehicle approaches the cliff is a predetermined value, and calculate a lateral displacement amount of the vehicle corresponding to the trajectory; a guard value setting unit configured to set a guard value for limiting the steering angle change rate by comparing the lateral distance with the lateral displacement amount; and a vehicle controller configured to control the vehicle based on the guard value.
(2) The steering limitation device according to (1), in which: the displacement amount calculation unit is configured to gradually increase the predetermined value until the lateral displacement amount exceeds a threshold value equal to or less than the lateral distance; and the guard value setting unit is configured to set the guard value to the predetermined value immediately before the lateral displacement amount exceeds the threshold value.
(3) The steering limitation device according to (1) or (2), in which the vehicle controller is configured to issue a warning to an occupant of the vehicle when the steering angle change rate reaches the guard value.
(4) The steering limitation device according to (1) or (2), in which the vehicle controller is configured to control steering of the vehicle such that the steering angle change rate does not exceed the guard value.
(5) A steering limitation method executed by a computer, the steering limitation method including: calculating a lateral distance between a vehicle and a cliff when a road on which the vehicle travels faces the cliff; estimating a trajectory of the vehicle when a steering angle change rate of the vehicle in a direction in which the vehicle approaches the cliff is a predetermined value, and calculating a lateral displacement amount of the vehicle corresponding to the trajectory; setting a guard value for limiting the steering angle change rate by comparing the lateral distance with the lateral displacement amount; and controlling the vehicle based on the guard value.

According to the present disclosure, traveling of a vehicle can be appropriately supported when the vehicle travels on a road facing a cliff.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a steering limitation system including a steering limitation device according to a first embodiment of the present disclosure;

FIG. 2 is a functional block diagram of a processor of an ECU;

FIG. 3 is a diagram schematically showing a vehicle traveling on a road facing a cliff;

FIG. 4 is a flowchart showing a control routine related to guard value setting processing in the first embodiment;

FIG. 5 is a flowchart showing a control routine related to steering suppression processing in the first embodiment; and

FIG. 6 is a flowchart showing a control routine related to steering suppression processing in a second embodiment.

### DETAILED DESCRIPTION OF EMBODIMENTS

Hereinafter, embodiments of the present disclosure will be described in detail with reference to the drawings. In the following description, the same reference numerals are given to the same constituent elements.

### First Embodiment

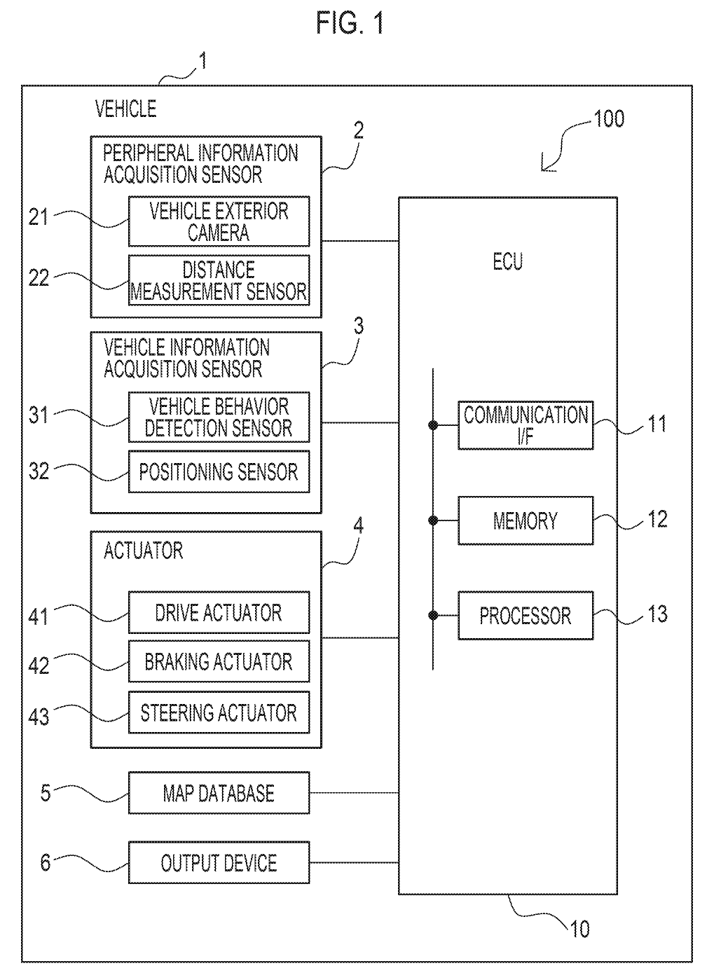

Hereinafter, a first embodiment of the present disclosure will be described with reference to FIGS. 1-5. FIG. 1 is a schematic configuration diagram of a steering limitation system 100 including a steering limitation device according to the first embodiment of the present disclosure. The steering limitation system 100 is mounted in a vehicle 1 and controls the vehicle 1 to limit steering of the vehicle 1. In the present embodiment, the vehicle 1 is an automobile with four wheels.

As shown in FIG. 1, the steering limitation system 100 includes the following components: a peripheral information acquisition sensor 2; a vehicle information acquisition sensor 3; an actuator 4; a map database 5; an output device 6; and an electronic control unit (ECU) 10. The peripheral information acquisition sensor 2, the vehicle information acquisition sensor 3, the actuator 4, the map database 5, and the output device 6 are electrically connected to the ECU 10 via an in-vehicle network or the like conforming to a standard. Examples of the in-vehicle network include a controller area network (CAN) or an Ethernet.

The peripheral information acquisition sensor 2 acquires peripheral information of the vehicle 1 (own vehicle). The peripheral information acquisition sensor 2 generates peripheral data (for example, image data of an object around the vehicle 1, distance data, speed data, and azimuth data) of the vehicle 1 at predetermined periods, and transmits the peripheral data to the ECU 10. The peripheral information acquisition sensor 2 includes, for example, a vehicle exterior camera 21 and a distance measurement sensor 22.

The vehicle exterior camera 21 images the periphery of the vehicle 1 to generate image data of the periphery of the vehicle 1. In the present embodiment, the vehicle exterior camera 21 includes at least a front camera that images a front of the vehicle 1 to generate image data of the front of the vehicle 1. A plurality of cameras may be provided in the vehicle 1 as the vehicle exterior camera 21. For example, the vehicle exterior camera 21 may include the following configurations in addition to the front camera: a left side camera that images a left side of the vehicle 1 to generate image data of the left side of the vehicle 1; a right side camera that images a right side of the vehicle 1 to generate image data of the right side of the vehicle 1; and a rear camera that images a rear of the vehicle 1 to generate image data of the rear of the vehicle 1. In addition, the vehicle exterior camera 21 may be a monocular camera or a stereo camera.

The distance measurement sensor 22 detects the presence of an object around the vehicle 1 by irradiating the periphery of the vehicle 1 with electromagnetic waves (millimeter waves or laser light) or ultrasonic waves, and measures a distance from the vehicle 1 to the object. In addition, the distance measurement sensor 22 can also measure a speed and an azimuth of the object around the vehicle 1. That is, the distance measurement sensor 22 generates distance data, speed data, azimuth data, and the like of the object around the vehicle 1. The distance measurement sensor 22 includes, for example, at least one of a millimeter wave radar, a laser imaging detection and ranging (LiDAR), or a sonar (ultrasonic sensor).

The vehicle information acquisition sensor 3 acquires vehicle information (own vehicle information). The vehicle information acquisition sensor 3 generates vehicle data (behavior data, self-position data, and the like of the vehicle 1) related to the vehicle information at predetermined periods, and transmits the vehicle data to the ECU 10. The vehicle information acquisition sensor 3 includes, for example, a vehicle behavior detection sensor 31 and a positioning sensor 32.

The vehicle behavior detection sensor 31 detects a behavior (traveling state) of the vehicle 1 and generates behavior data of the vehicle 1. The vehicle behavior detection sensor 31 includes, for example, a vehicle speed sensor that detects a speed of the vehicle 1, and a steering angle sensor that detects a steering angle (a steering angle of a steered wheel (for example, a front wheel of the vehicle 1)) of the vehicle 1. That is, the vehicle behavior detection sensor 31 generates speed data, steering angle data, and the like of the vehicle 1 as the behavior data of the vehicle 1.

The positioning sensor 32 measures a self-position of the vehicle 1 and generates self-position data of the vehicle 1. For example, the positioning sensor 32 is a global navigation satellite system (GNSS) receiver. The GNSS receiver detects a current position (for example, a latitude and a longitude of the vehicle 1) of the vehicle 1 based on positioning information obtained from a plurality (for example, three or more) of positioning satellites. A specific example of the GNSS receiver is a global positioning system (GPS) receiver.

The actuator 4 operates the vehicle 1 in response to an operation by a driver of the vehicle 1, an instruction from the ECU 10, and the like. The actuator 4 includes, for example, a drive actuator 41, a braking actuator 42, and a steering actuator 43. The drive actuator 41 controls acceleration of the vehicle 1 via a drive device (for example, at least one of an internal combustion engine or an electric motor) of the vehicle 1. The braking actuator 42 controls braking of the vehicle 1. The steering actuator 43 controls steering of the vehicle 1. In the present embodiment, the ECU 10 controls the behavior of the vehicle 1 (for example, the acceleration, the braking, and the steering of the vehicle 1) using the actuator 4. That is, the vehicle 1 is an autonomous driving vehicle in which at least one of the acceleration, the braking, or the steering of the vehicle 1 is automatically controlled.

The map database 5 stores map information. The map information includes road information (for example, position information of a road, shape information of a road (for example, a type of a curve and a straight portion, a curvature radius of a curve, and a road gradient), and peripheral information of a road (for example, the presence or absence of a cliff)). The ECU 10 acquires the map information from the map database 5. The map database 5 may be provided outside the vehicle 1 (for example, a server), and the ECU 10 may acquire the map information from outside the vehicle 1.

The output device 6 notifies an occupant (for example, a driver) of the vehicle 1. The output device 6 includes at least one of a display, a warning lamp, a speaker, a buzzer, or a vibration unit. The output device 6 notifies the occupant of the vehicle 1 of an output corresponding to a signal transmitted from the ECU 10.

The ECU 10 executes various controls of the vehicle 1. As shown in FIG. 1, the ECU 10 includes a communication interface 11, a memory 12, and a processor 13. The communication interface 11 and the memory 12 are connected to the processor 13 via a signal line. In the present embodiment, one ECU 10 is provided, but a plurality of ECUs may be provided for each function. In addition, the communication interface 11, the memory 12, and the processor 13 may be configured as one integrated circuit, or may be configured as separate circuits, respectively.

The communication interface 11 has an interface circuit for connecting the ECU 10 to the in-vehicle network. The ECU 10 is connected to other in-vehicle devices via the communication interface 11. The communication interface 11 transmits a signal received from the peripheral information acquisition sensor 2, the vehicle information acquisition sensor 3, and the map database 5 to the processor 13. In addition, the communication interface 11 transmits a signal output from the processor 13 to the actuator 4 and the output device 6.

The memory 12 includes, for example, a volatile semiconductor memory (for example, a dynamic random access memory (DRAM) and a static random access memory (SRAM)) and a non-volatile semiconductor memory (for example, a read only memory (ROM), an electrically erasable programmable read only memory (EEPROM), and a flash memory). The memory 12 stores temporary data, a computer program (a control program of the ECU 10) used for various types of processing by the processor 13, setting data of the ECU 10, log data, vehicle information, and the like.

The processor 13 includes one or a plurality of central processing units (CPUs) and a peripheral circuit thereof. The processor 13 executes a computer program stored in the memory 12. The processor 13 may further include another arithmetic circuit, such as a logic operation unit, a numerical operation unit, or a graphic processing unit.

In the present embodiment, the ECU 10 functions as a steering limitation device that controls the vehicle 1 to limit the steering of the vehicle 1. In particular, in the present embodiment, the ECU 10 controls the vehicle 1 to limit the steering of the vehicle 1 when the road on which the vehicle 1 travels faces the cliff. Therefore, the ECU 10 supports traveling of the vehicle 1 by limiting the steering of the vehicle 1. The ECU 10 is an example of a steering limitation device.

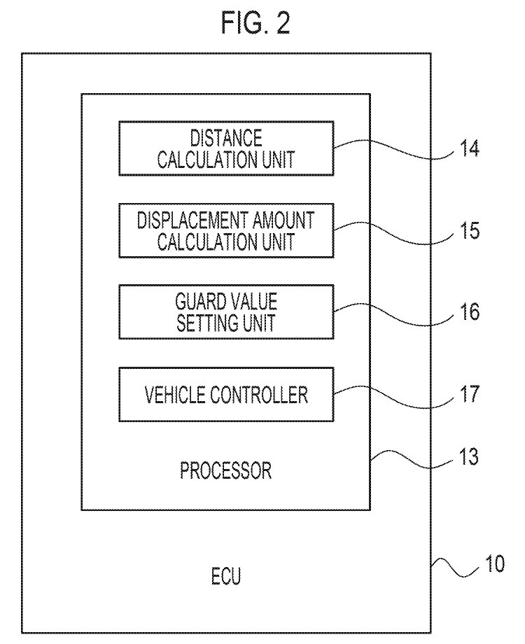

FIG. 2 is a functional block diagram of the processor 13 of the ECU 10. As shown in FIG. 2, the processor 13 includes a distance calculation unit 14, a displacement amount calculation unit 15, a guard value setting unit 16, and a vehicle controller 17. The distance calculation unit 14, the displacement amount calculation unit 15, the guard value setting unit 16, and the vehicle controller 17 are functional modules that are implemented by the processor 13 of the ECU 10 executing the computer program stored in the memory 12 of the ECU 10. Each of the functional modules may be implemented by a dedicated arithmetic circuit provided in the processor 13.

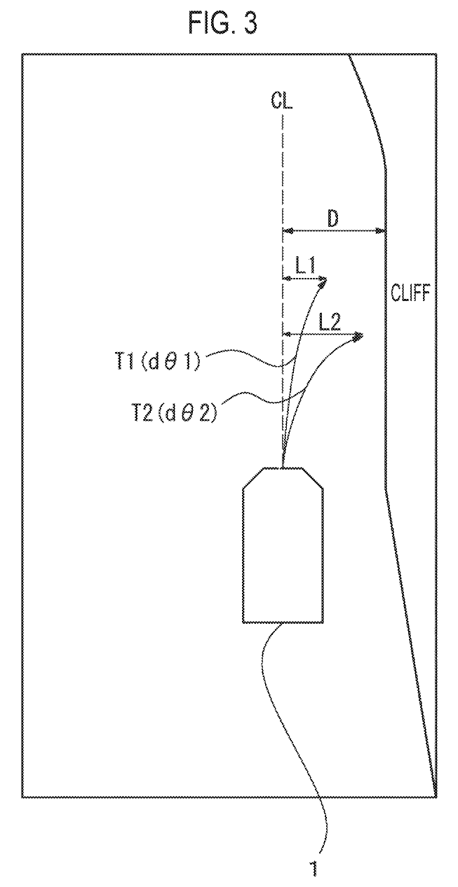

FIG. 3 is a diagram schematically showing the vehicle 1 traveling on the road facing the cliff. In the example of FIG. 3, the cliff is present on a right side of the road. The distance calculation unit 14 calculates the lateral distance D between the vehicle 1 and the cliff. For example, as shown in FIG. 3, the distance calculation unit 14 calculates a distance between a vehicle width center line CL of the vehicle 1 and the cliff (edge of the cliff) in a direction (lateral direction) perpendicular to a traveling direction of the vehicle 1 as the lateral distance D. In the present embodiment, the distance calculation unit 14 calculates the lateral distance D based on an output of the peripheral information acquisition sensor 2 (for example, the LiDAR of the distance measurement sensor 22).

The displacement amount calculation unit 15 estimates a trajectory of the vehicle 1 when a steering angle change rate of the vehicle 1 in a direction (right direction in the example of FIG. 3) in which the vehicle 1 approaches the cliff is a predetermined value, and calculates a lateral displacement amount of the vehicle 1 corresponding to the estimated trajectory. For example, the displacement amount calculation unit 15 estimates the trajectory of the vehicle 1 when it is assumed that the steering angle change rate of the vehicle 1 is maintained at the predetermined value for a predetermined time (for example, 0.5 seconds to 3 seconds).

In the example of FIG. 3, the displacement amount calculation unit 15 estimates a first trajectory T1 of the vehicle 1 when the steering angle change rate of the vehicle 1 is a first steering angle change rate dθ1, and calculates a lateral displacement amount L1 of the vehicle 1 corresponding to the first trajectory T1. In addition, the displacement amount calculation unit 15 estimates a second trajectory T2 of the vehicle 1 when the steering angle change rate of the vehicle 1 is a second steering angle change rate dθ2 larger than the first steering angle change rate dθ1, and calculates a lateral displacement amount L2 of the vehicle 1 corresponding to the second trajectory T2. The lateral displacement amount L1 is a distance that the vehicle 1 moves in the lateral direction when it is assumed that the vehicle 1 travels on the first trajectory T1, and the lateral displacement amount L2 is a distance that the vehicle 1 moves in the lateral direction when it is assumed that the vehicle 1 travels on the second trajectory T2.

For example, the displacement amount calculation unit 15 estimates the trajectory of the vehicle 1 based on the steering angle change rate of the vehicle 1 and the speed (vehicle speed) of the vehicle 1. As a specific example, the displacement amount calculation unit 15 estimates the trajectory of the vehicle 1 by the following method. Specifically, the displacement amount calculation unit 15 inputs the steering angle change rate of the vehicle 1 and the speed of the vehicle 1 as input parameters, and obtains a numerical solution of a differential equation of a kinematic model by numerical integration using an Euler method or a fourth-order Runge-Kutta method. The displacement amount calculation unit 15 may use a dynamic model that takes into account a force acting on the vehicle 1, inertia of the vehicle 1, and the like, instead of the kinematic model as the vehicle motion model.

The guard value setting unit 16 sets the guard value for limiting the steering angle change rate of the vehicle 1 by comparing the lateral distance D with the lateral displacement amounts L1 and L2 of the vehicle 1. In the example of FIG. 3, the lateral displacement amounts L1 and L2 are shorter than the lateral distance D, and the lateral displacement amount L2 is longer than the lateral displacement amount L1. In this case, for example, the guard value setting unit 16 sets the second steering angle change rate dθ2 corresponding to the lateral displacement amount L2 as the guard value.

The vehicle controller 17 controls the vehicle 1 based on the guard value set by the guard value setting unit 16. In the present embodiment, the vehicle controller 17 controls the steering of the vehicle 1 such that the steering angle change rate of the vehicle 1 does not exceed the guard value. As a result, it is possible to avoid the vehicle 1 from excessively approaching the cliff, and it is possible to appropriately support the traveling of the vehicle 1 when the vehicle 1 travels on the road facing the cliff.

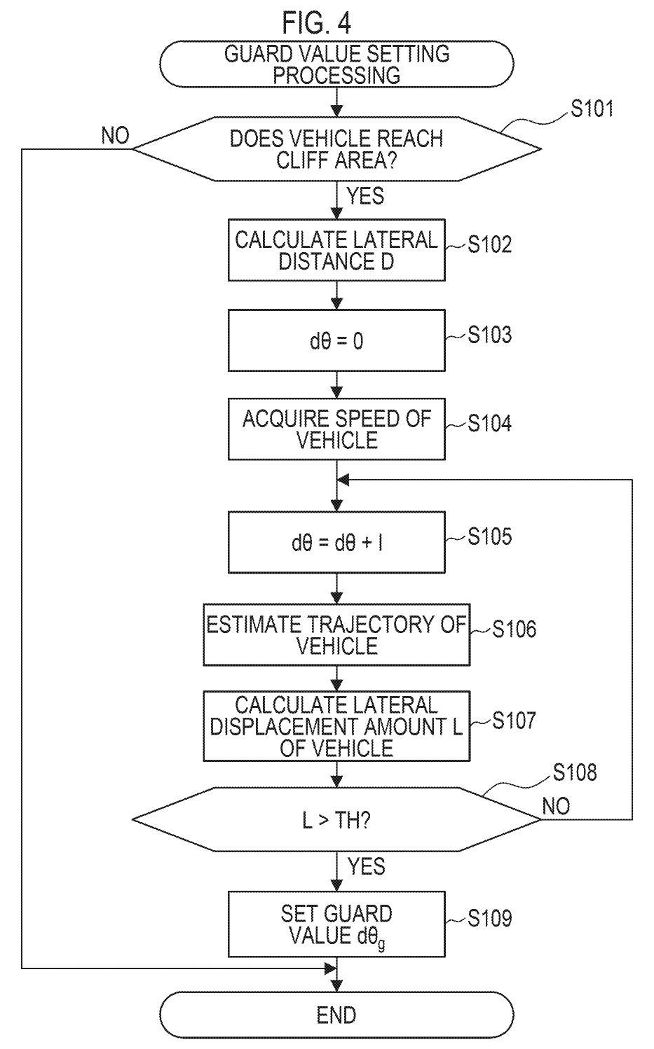

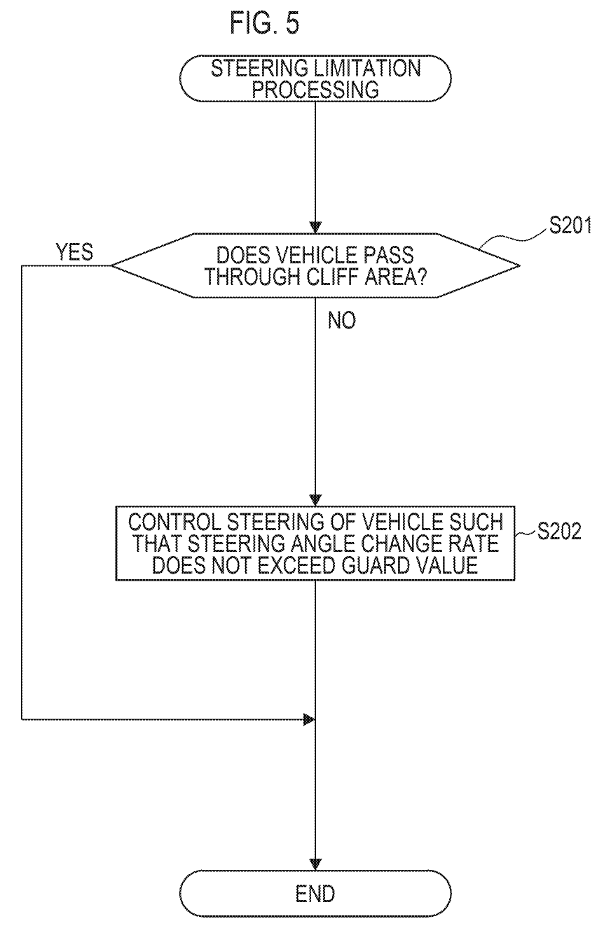

Hereinafter, a flow of processing for executing the control will be described with reference to the flowcharts of FIGS. 4 and 5. FIG. 4 is a flowchart showing a control routine related to the guard value setting processing in the first embodiment. This control routine is repeatedly executed by the processor 13 of the ECU 10 in accordance with, for example, the computer program stored in the memory 12 of the ECU 10.

In the control routine of the guard value setting processing of FIG. 4, the displacement amount calculation unit 15 gradually increases the steering angle change rate of the vehicle 1 in a case of estimating the trajectory of the vehicle 1 until the lateral displacement amount of the vehicle 1 exceeds the threshold value that is equal to or less than the lateral distance. Then, the guard value setting unit 16 sets the value of the steering angle change rate immediately before the lateral displacement amount exceeds the threshold value as the guard value. As a result, the guard value can be set to an appropriate value that enables the vehicle 1 to take a natural path while the vehicle 1 is avoided from excessively approaching the cliff. Hereinafter, a specific flow of the control will be described.

First, in S101, the distance calculation unit 14 of the processor 13 determines whether the vehicle 1 has reached a cliff area (hereinafter, simply referred to as a "cliff area") in which the road faces the cliff. For example, the distance calculation unit 14 acquires the current position of the vehicle 1 based on the output of the positioning sensor 32, and acquires map information around the current position of the vehicle 1 from the map database 5. Then, the distance calculation unit 14 determines whether the vehicle 1 has reached the cliff area with reference to the road information included in the map information. The distance calculation unit 14 may determine whether the vehicle 1 has reached the cliff area based on the output of the peripheral information acquisition sensor 2.

When it is determined in S101 that the vehicle 1 has not reached the cliff area, the present control routine ends. On the other hand, when it is determined in S101 that the vehicle 1 has reached the cliff area, the present control routine proceeds to S102.

In S102, the distance calculation unit 14 calculates the lateral distance D between the vehicle 1 and the cliff based on, for example, the output of the peripheral information acquisition sensor 2. When the lateral distance D is not constant in the cliff area in front of the vehicle 1, the distance calculation unit 14 calculates, for example, a minimum value of the lateral distance D in a predetermined range in front of the vehicle as the lateral distance D.

Next, in S103, the displacement amount calculation unit 15 of the processor 13 resets the steering angle change rate dθ of the vehicle 1 to zero. The direction of the steering angle change rate dθ is set to the direction in which the vehicle 1 approaches the cliff (right side in the example of FIG. 3).

Next, in S104, the displacement amount calculation unit 15 acquires the speed of the vehicle 1 based on the output of the vehicle speed sensor of the vehicle behavior detection sensor 31.

Next, in S105, the displacement amount calculation unit 15 updates the steering angle change rate dθ by adding a predetermined incremental value I to the steering angle change rate dθ.

Next, in S106, the displacement amount calculation unit 15 estimates the trajectory of the vehicle 1 when it is assumed that the vehicle 1 travels at the steering angle change rate dθ based on the steering angle change rate dθ and the speed of the vehicle 1.

Next, in S107, the displacement amount calculation unit 15 calculates the lateral displacement amount L of the vehicle 1 corresponding to the trajectory of the vehicle 1 estimated in S106.

Next, in S108, the guard value setting unit 16 of the processor 13 determines whether the lateral displacement amount L is larger than a predetermined threshold value TH. The threshold value TH is set to a value equal to or less than the lateral distance D, and is set to, for example, a value obtained by subtracting a predetermined distance (for example, several tens of cm to several m) from the lateral distance D. The threshold value TH may be set to the same value as the lateral distance D.

When it is determined in S108 that the lateral displacement amount L is equal to or less than the threshold value TH, the present control routine returns to S105. In this case, the steering angle change rate dθ is updated in S105, and S106 and S107 are executed again for the increased steering angle change rate dθ.

On the other hand, when it is determined in S108 that the lateral displacement amount L is larger than the threshold value TH, the present control routine proceeds to S109. In S109, the guard value setting unit 16 sets the guard value dθ_{g} for limiting the steering angle change rate of the vehicle 1. Specifically, the guard value setting unit 16 sets the value (dθ − I) immediately before the steering angle change rate dθ, that is, the value of the steering angle change rate dθ immediately before the lateral displacement amount L exceeds the threshold value TH, as the guard value dθ_{g}. After S109, the present control routine ends.

FIG. 5 is a flowchart showing a control routine related to the steering suppression processing in the first embodiment. This control routine is repeatedly executed by the processor 13 of the ECU 10 in accordance with, for example, the computer program stored in the memory 12 of the ECU 10.

First, in S201, the vehicle controller 17 of the processor 13 determines whether the vehicle 1 has passed through the cliff area. For example, the vehicle controller 17 determines whether the vehicle 1 has passed through the cliff area with reference to the road information included in the map information around the current position of the vehicle 1. The vehicle controller 17 may determine whether the vehicle 1 has passed through the cliff area based on the output of the peripheral information acquisition sensor 2.

When it is determined in S201 that the vehicle 1 has passed through the cliff area, the present control routine ends. On the other hand, when it is determined in S201 that the vehicle 1 has not passed through the cliff area, the present control routine proceeds to S202.

In S202, the vehicle controller 17 controls the steering of the vehicle 1 using the steering actuator 43 of the actuator 4 such that the steering angle change rate of the vehicle 1 does not exceed the guard value dθ_{g}. After S202, the present control routine ends.

### Second Embodiment

A configuration and control of the steering suppression device according to the second embodiment are basically the same as the configuration and control of the steering suppression device according to the first embodiment, except that the following will be described. Therefore, hereinafter, the second embodiment of the present disclosure will be described with the different parts from the first embodiment.

In the second embodiment, the vehicle 1 is a manual driving vehicle in which all of the acceleration, the braking, and the operation of the vehicle 1 are controlled by the driver of the vehicle 1. In this case, the vehicle controller 17 issues a warning to the occupant (for example, the driver) of the vehicle 1 when the steering angle change rate of the vehicle 1 reaches the guard value. As a result, it is possible to avoid the vehicle 1 from excessively approaching the cliff, and it is possible to appropriately support the traveling of the vehicle 1 when the vehicle 1 travels on the road facing the cliff.

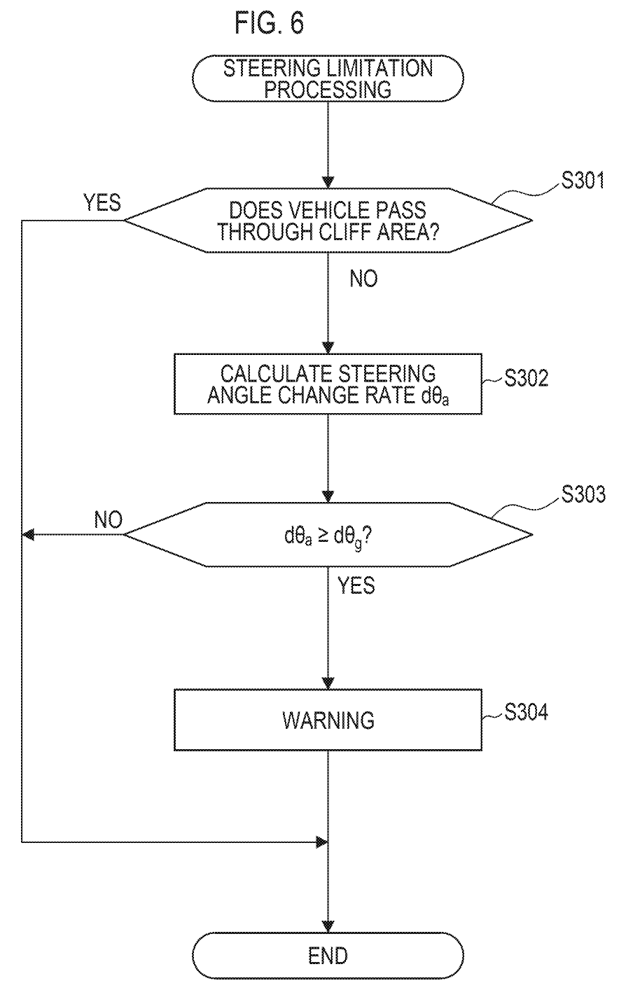

In the second embodiment, the control routine of the guard value setting processing of FIG. 4 is executed as in the first embodiment. On the other hand, in the second embodiment, the control routine of the steering suppression processing of FIG. 6 is executed instead of the control routine of the steering suppression processing of FIG. 5.

FIG. 6 is a flowchart showing a control routine related to steering suppression processing in a second embodiment. This control routine is repeatedly executed by the processor 13 of the ECU 10 in accordance with, for example, the computer program stored in the memory 12 of the ECU 10.

First, in S301, the vehicle controller 17 of the processor 13 determines whether the vehicle 1 has passed through the cliff area as in S201 of FIG. 5. When it is determined in S301 that the vehicle 1 has passed through the cliff area, the present control routine ends. On the other hand, when it is determined in S301 that the vehicle 1 has not passed through the cliff area, the present control routine proceeds to S302.

In S302, the vehicle controller 17 calculates the steering angle change rate dθₐ of the vehicle 1 based on the output of the steering angle sensor of the vehicle behavior detection sensor 31. In the present embodiment, the steering angle change rate dθₐ changes in response to the steering operation of the driver of the vehicle 1.

Next, in S303, the vehicle controller 17 determines whether the steering angle change rate dθₐ is equal to or larger than the guard value dθ_{g}set in S109 of FIG. 4. When it is determined that the steering angle change rate dθₐ is smaller than the guard value dθ_{g}, the present control routine ends. On the other hand, when it is determined that the steering angle change rate dθₐ is equal to or larger than the guard value dθ_{g}, the present control routine proceeds to S304.

In S304, the vehicle controller 17 issues a warning to the occupant of the vehicle 1. For example, the vehicle controller 17 issues a visual, auditory, or tactile warning to the occupant of the vehicle 1 via the output device 6. An example of the tactile warning is vibration of a steering wheel of the vehicle 1 by the vibration unit of the output device 6. After S304, the present control routine ends.

### Other Embodiments

Although the preferred embodiments of the present disclosure have been described, the present disclosure is not limited to the embodiments, and various changes and modifications can be made within the scope of the claims.

For example, a server that is provided outside the vehicle 1 and is communicable with the vehicle 1 may function as the steering limitation device. In this case, information needed for executing the control is transmitted from the vehicle 1 to the server, and the ECU 10 of the vehicle 1 controls the vehicle 1 based on an instruction from the server.

In addition, a computer program that causes a computer to implement functions of each unit of the processor 13 of the ECU 10 or the processor of the server may be provided in the following form. Specifically, the computer program is in a form stored in a computer-readable recording medium or a form included in a computer program product. The computer-readable recording medium is, for example, a magnetic recording medium, an optical recording medium, or a semiconductor memory.

What is claimed is:

1. A steering limitation device comprising:
a distance calculation unit configured to calculate a lateral distance between a vehicle and a cliff when a road on which the vehicle travels faces the cliff;
a displacement amount calculation unit configured to estimate a trajectory of the vehicle when a steering angle change rate of the vehicle in a direction in which the vehicle approaches the cliff is a predetermined value, and calculate a lateral displacement amount of the vehicle corresponding to the trajectory;
a guard value setting unit configured to set a guard value for limiting the steering angle change rate by comparing the lateral distance with the lateral displacement amount; and
a vehicle controller configured to control the vehicle based on the guard value.

2. The steering limitation device according to claim 1, wherein:
the displacement amount calculation unit is configured to gradually increase the predetermined value until the lateral displacement amount exceeds a threshold value equal to or less than the lateral distance; and
the guard value setting unit is configured to set the guard value to the predetermined value immediately before the lateral displacement amount exceeds the threshold value.

3. The steering limitation device according to claim 1, wherein the vehicle controller is configured to issue a warning to an occupant of the vehicle when the steering angle change rate reaches the guard value.

4. The steering limitation device according to claim 1, wherein the vehicle controller is configured to control steering of the vehicle such that the steering angle change rate does not exceed the guard value.

5. A steering limitation method executed by a computer, the steering limitation method comprising:
calculating a lateral distance between a vehicle and a cliff when a road on which the vehicle travels faces the cliff;
estimating a trajectory of the vehicle when a steering angle change rate of the vehicle in a direction in which the vehicle approaches the cliff is a predetermined value, and calculating a lateral displacement amount of the vehicle corresponding to the trajectory;
setting a guard value for limiting the steering angle change rate by comparing the lateral distance with the lateral displacement amount; and
controlling the vehicle based on the guard value.
